(19) United States
(12) Patent Application Publication
(10) Pub. No.: US 2006/0027654 A1
(43) Pub. Date: Feb. 9, 2006

(54) Card reader and data transmission method therefor

(76) Inventors: Chi-Tung Chang, Taipei County (TW); Wen-Chao Tseng, Taipei County (TW); Chao-Yu Chen, Taipei County (TW)

Correspondence Address: Chi-Tung Chang, 7F., No. 213, Civic Boulevard. Sec. 4, Taipei, 105, TW

(21) Appl. No.: 10/910,754

(22) Filed: Aug. 4, 2004

(51) Int. Cl. G06K 7/06

(52) U.S. Cl. 235/441

(57) ABSTRACT

A structurally integrated and simplified card reader includes a data I/O interface, via which data are input or output to or from the card reader; a managing system for controlling and managing data input/output to/from the card reader; at least one data reading device adapted to connect to at least one type of memory device for controlling access of data input/output to/from the memory device; and at least one data-sharing control device for providing a path for accessing data input/output to/from the memory device. When the data I/O interface is connected to a computer system, and the memory device is connected to the data reading device and the data-sharing control device, the managing system and the computer system cooperate to detect and control data input/output to/from the memory device via the path provided by the data-sharing control device.

### FIELD OF THE INVENTION

The present invention relates to a card reader, and more particularly to a card reader having integrated and simplified structure. The present invention also relates to a data transmission method for the card reader.

### BACKGROUND OF THE INVENTION

The card readers currently available in the market are generally divided into two types, that is, built-in and externally connected card readers. For either type, it is very important for the card reader to have simple structure and reduced volume, so that a consumer could conveniently mount the card reader on a general personal computer or a notebook computer for use at different places. Meanwhile, the reduced volume also reduces the manufacturing cost of the card reader to benefit both the consumers and the manufacturers. Therefore, it has become an inevitable trend to develop compact card readers with minimized volume and weight.

FIG. 1 is a block diagram showing the structure of a conventional card reader. As shown, the conventional card reader mainly includes a data input/output (I/O) interface 11′, which is a USB interface; a managing system 13′, which includes a control unit 131′, a memory unit 133′, and a processing unit 135′; and a data reading device 15′, which includes a first card reading device 151′ for reading a Compact Flash card, a second card reading device 153′ for reading a Memory Stick card, a third card reading device 155′ for reading a Smart Media card, and a fourth card reading device 157′ for reading a Secure Digital card. The data reading device 15′ is normally available in the market in two configurations, namely, having one single card slot adapted to read more than one type of memory card (a multiple-in-one card slot), and having more than one card slot for reading a different type of memory card each. Each of the card reading devices of the data reading device 15′ controls the reading and the access of a corresponding memory card via two communicating interfaces. For example, the card reading device 151′ for reading a Compact Flash card 171′ is connected to the Compact Flash card 171′ via an eight-terminal data transmission interface 1511′ and a control interface 1513′; the card reading device 153′ for reading a Memory Stick card 173′ is connected to the Memory Stick card 173′ via a four-terminal data transmission interface 1531′ and a control interface 1533′; the card reading device 155′ for reading a Smart Media card 175′ is connected to the Smart Media card 175′ via an eight-terminal data transmission interface 1551′ and a control interface 1553′; and the card reading device 157′ for reading a Secure Digital/Multi-media card 177′ is connected to the Secure Digital/Multi-media card 177′ via a four-terminal data transmission interface 1571′ and a control interface 1573′.

The large numbers of terminals on the data transmission interfaces often complicate the card readers and increase the cost thereof. In the example illustrated in FIG. 1, total 24 terminals are provided for data transmission to largely increase the cost thereof. Moreover, when any one of the terminals is deformed or otherwise damaged, particularly in the case of one single card slot for reading multiple types of cards, it is very possible to take a lot of time and cost to repair the card reader, or to result in a completely failed card reader.

It is therefore desirable to develop an improved card reader to overcome the problems existed in the conventional card readers.

### SUMMARY OF THE INVENTION

A primary object of the present invention is to provide a card reader that has simplified internal structure to minimize the probability of failure, and accordingly, the maintenance cost of the card reader.

Another object of the present invention is to provide a card reader that has reduced volume to occupy a minimal space when being connected to a general personal computer, and to be conveniently carried when being assembled to a notebook computer.

A further object of the present invention is to provide a card reader that has simplified structure to enable reduced manufacturing cost thereof and accordingly, wide applications of the card reader as a built-in device of a desktop computer, an independent USB card reader, a built-in card reader of a notebook computer, a built-in USB card reader for a printer, a built-in USB card reader for a household appliance, an electronic photo album, a built-in card reader for a portable product and a mobile phone, etc.

A still further object of the present invention is to provide a method of data transmission for card reader, so that data could be easily and rapidly transmitted during reading via a structurally integrated card reader and a unique data transmission path.

To achieve the above and other objects, the structurally integrated and simplified card reader according to the present invention includes a data I/O interface, via which data are input or output to or from the card reader; a managing system for controlling and managing data I/O; at least one data reading device adapted to connect to at least one type of memory device for controlling access of data input/output to/from the memory device; and at least one data-sharing control device for providing a path for accessing data input/output to/from the memory device.

When the data I/O interface is connected to a computer system, and the memory device is connected to the data reading device and the data-sharing control device, the managing system and the computer system cooperate to detect and control data input/output to/from the memory device via the path provided by the data-sharing control device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing an internal structure of a conventional card reader;

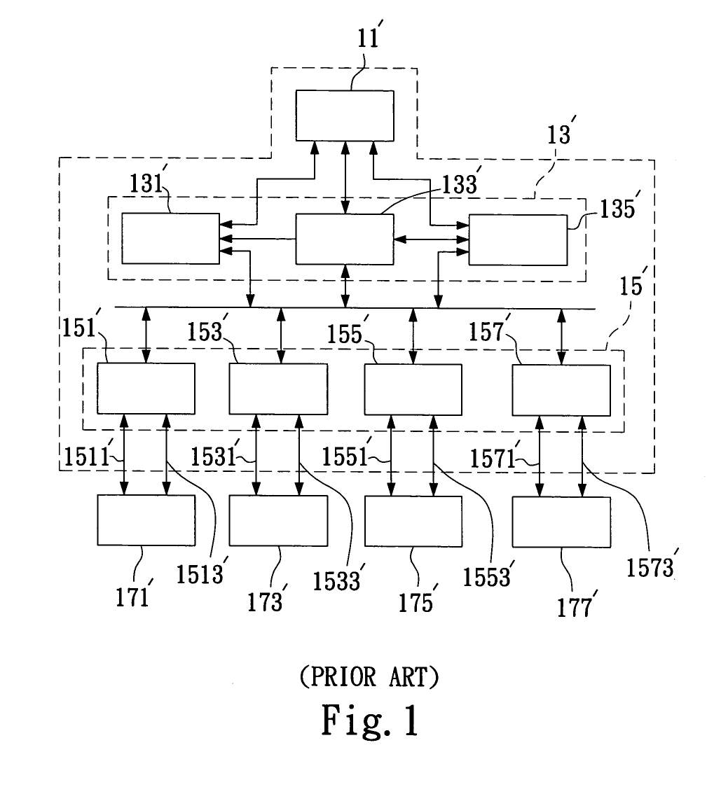

FIG. 2 is a block diagram showing an internal structure of a card reader according to the present invention; and

FIG. 3 is a flowchart showing steps included in a method employed by the card reader of the present invention for data transmission.

### DETAILED DESCRIPTION OF THE PREFERRED EMBODIMENTS

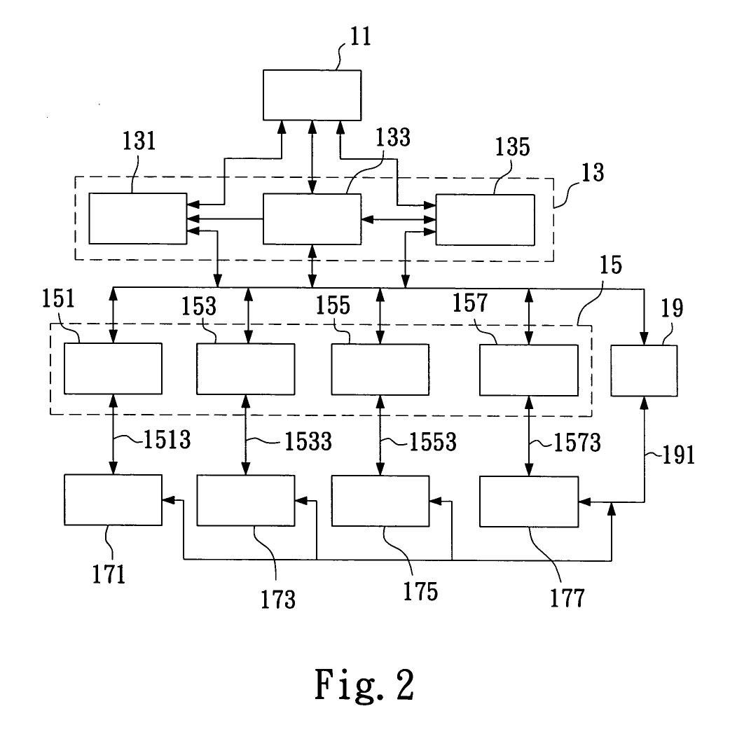

Please refer to FIG. 2 that is a block diagram showing an internal structure of a card reader according to the present invention. As shown, the card reader of the present invention mainly includes a data input/output (I/O) interface 11 via which data is input or output to or from the card reader, and the data I/O interface 11 may be a USB, a 1394, an RS232, a COM port, a parallel port, a PS 2, a PCMCIA, an 802.11 series, a Bluetooth, or an infrared system, so as to enable diversified transmission manners; a managing system 13 that is used to control and manage input and output of data to and from the card reader, and further includes a control unit 131, a memory unit 133, and a processing unit 135 for performing the aforesaid functions; and a data reading device 15 that is adapted to connect to at least one type of memory device for controlling the access of data input/output to/from the memory device, and may be a memory card access device, such as, for example, a card slot, to communicate with the memory device about control instructions via a simple control line. The card slot may be any one of the following two configurations: a multiple-in-one card slot and multiple card slots. And, the memory device may be any one of the following types: Compact Flash Card, IBM Micro-drive, Smart Media Card, xD-picture Card, Multi-media Card, Secure Digital Card, Memory Stick Card, and Memory Stick Pro Card.

Please refer to FIG. 2. The data reading device 15 includes a first card reading device 151, a second card reading device 153, a third card reading device 155, and a fourth card reading device 157, which are respectively connected to a first, a second, a third, and a fourth memory device 171, 173, 175, and 177 via a first, a second, a third, and a fourth control line 1513, 1533, 1553, and 1573 respectively, so as to control the access of these memory devices when they are connected to the data reading device 15. A data-sharing control device 19 provides a data access path for data input/output to/from the memory devices. Data is transmitted between the data-sharing control device 19 and individual memory devices 171, 173, 175, 177 via one single simple and integrated data transmission line 191, which has only 8 terminals. In brief, when the data I/O interface 11 is connected to a computer system (not shown), such as a general computer, a data storing device, etc., and any one or more of the memory devices 171, 173, 175, 177 are coupled with the data reading device 15 and the data-sharing control device 19, the managing system 13 and the connected computer system cooperate to detect and control data input/output to/from the memory devices. And, the data are input and output via the only path provided by the data-sharing control device 19, that is, the data transmission line 191. Since the integrated data transmission line 191 has only eight terminals, that is largely reduced as compared with the twenty-four terminals in the prior art, it enables largely reduced manufacturing and maintenance costs of the card reader.

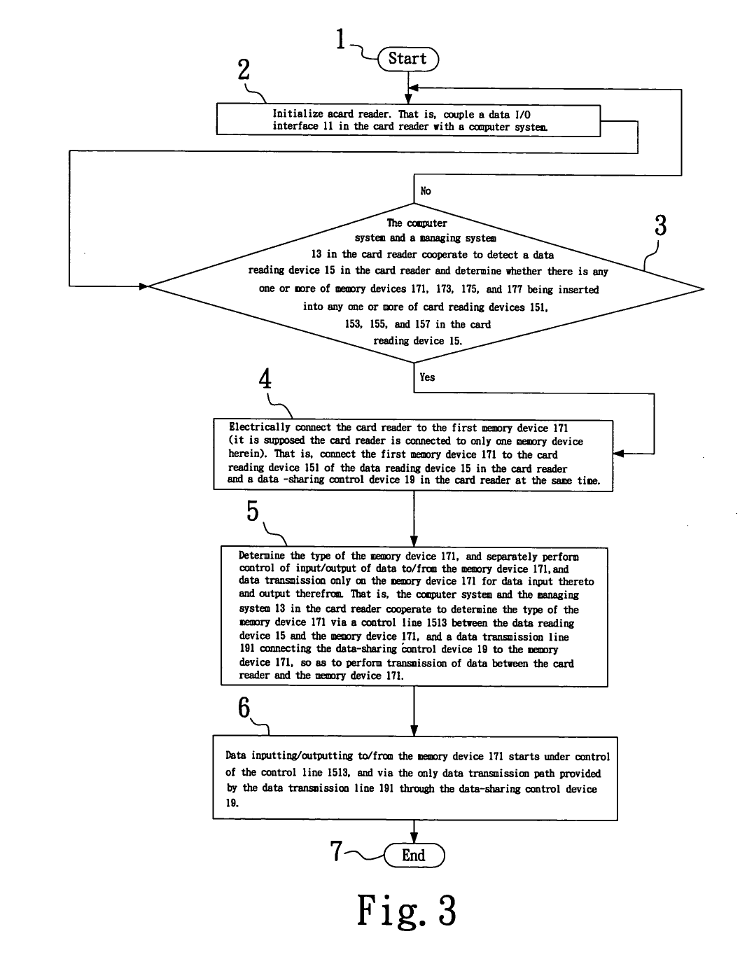

Please refer to FIG. 3, which is a flowchart showing steps included in a method employed by the card reader of the present invention to transmit data. The method includes the following steps:

Step (1): Start procedures for transmission of data;

Step (2): Initialize the card reader. That is, couple a data I/O interface in the card reader with a computer system;

Step (3): The computer system and a managing system 13 in the card reader cooperate to detect a data reading device 15 in the card reader and determine whether there is any one or more of memory devices 171, 173, 175, and 177 being inserted into any one or more of card reading devices 151, 153, 155, and 157 in the card reading device 15. If yes, the procedure goes to Step (4); and, if not, the procedure returns to the Step (2);

Step (4): Electrically connect the card reader to the first memory device 171 (it is supposed the card reader is connected to only one memory device herein). That is, connect the first memory device 171 to the card reading device 151 of the data reading device 15 in the card reader and a data-sharing control device 19 in the card reader at the same time;

Step (5): Determine the type of the memory device 171, and separately perform control of input/output of data to/from the memory device 171, and data transmission only on the memory device 171 for data input thereto and output therefrom. That is, the computer system and the managing system 13 in the card reader cooperate to determine the type of the memory device 171 via a control line 1513 between the data reading device 15 and the memory device 171 and a data transmission line 191 connecting the data-sharing control device 19 to the memory device 171, so as to perform transmission of data between the card reader and the memory device 171;

Step (6): Data inputting/outputting to/from the memory device 171 starts under control of the control line 1513, and via the only data transmission path provided by the data transmission line 191 through the data-sharing control device 19; and

Step (7): End the procedures. In the above-described method, the data I/O interface 11 of the card reader may be a USB, a 1394, an RS232, a COM port, a parallel port, a PS 2, a PCMCIA, an 802.11 series, a Bluetooth, or an infrared system, so as to enable diversified data transmission manners; and the managing system 13 further includes a control unit 131, a memory unit 133, and a processing unit 135; and the data reading device 15 is a memory card access device configured as, for example, a multiple-in-one card slot or including multiple card slots. And, the memory devices 171, 173, 175, 177 may be anyone of the following types: Compact Flash Card, IBM Micro-drive, Smart Media Card, xD-picture Card, Multi-media Card, Secure Digital Card, Memory Stick Card, and Memory Stick Pro Card. And, the computer system may be a general computer or a data-storing device.

From the above description, it is noted the card reader of the present invention and the data transmission method therefor are characterized in that data control and data transmission are separately processed. Particularly, a data-sharing control device 19 is additionally designed to enable integrated data transmission to ensure the simplicity during data transmission.

In summary, the card reader of the present invention and the data transmission method therefor have been structurally integrated and simplified to largely reduce manufacturing and maintenance costs thereof. Meanwhile, the data transmission method employed by the card reader of the present invention ensures the simplicity during data transmission.

What is claimed is:

1. A card reader, comprising:
a data input/output (I/O) interface, via which data are input and output to and from said card reader;
a managing system for controlling and managing input and output of said data to and from said card reader;
at least one data reading device adapted to electrically connect to at least one type of memory device, so as to control access of data to be input or output to or from said memory device; and
at least one data-sharing control device for providing a data access path, via which data is input or output to or from said memory device;
whereby when said data I/O interface is electrically connected to a computer system, and when said memory device is connected to said data reading device and said data-sharing control device, said managing system and said computer system cooperate to detect and control data input/output to/from said memory device via said path provided by said data-sharing control device.

2. The card reader as claimed in claim 1, wherein said data I/O interface is selected from the group consisting of USB, 1394, RS232, COM port, parallel port, PS2, PCMCIA, 802.11 series, Bluetooth, and infrared systems.

3. The card reader as claimed in claim 1, wherein said managing system further includes at least one control unit, at least one memory unit, and at least one processing unit.

4. The card reader as claimed in claim 1, wherein said data reading device comprises a card access device, such as a card slot configuration; and said data reading device communicating with said memory device about control instructions via one single simple control line.

5. The card reader as claimed in claim 4, wherein said card slot configuration is selected from the group consisting of a multiple-in-one card slot and a plurality of card slots.

6. The card reader as claimed in claim 1, wherein said memory device is of a type selected from the group consisting of Compact Flash Card, IBM Micro-drive, Smart Media Card, xD-picture Card, Multi-media Card, Secure Digital Card, Memory Stick Card, and Memory Stick Pro Card.

7. The card reader as claimed in claim 1, wherein said data transmission between said data-sharing control device and said memory device is performed via a simple data transmission line provided by said data-sharing control device.

8. The card reader as claimed in claim 1, wherein said computer system is selected from the group consisting of general computers and data storing devices.

9. A method of data transmission for card reader, comprising the steps of:
(1) Start;
(2) Initialize a card reader;
(3) Electrically connect said card reader to a memory device;
(4) Determine a type of said memory device, and separately perform control of data input/output to/from said memory device, and data transmission only to and from said memory device; and
(5) End.

10. The method of data transmission for card reader as claimed in claim 9, wherein the step (2) further includes the steps of:
(21) Electrically connect a data input/output (I/O) interface in said card reader to a computer system; and
(22) Allow said computer system to cooperate with a managing system in said card reader to detect a data reading device in said card reader, so as to determine whether there is at least one said memory device inserted into said data reading device; and, if yes, the Step (3) is proceeded with; and, if not, the Step (21) is performed again.

11. The method of data transmission for card reader as claimed in claim 9, wherein the Step (3) further includes the step of:
(31) Electrically connect said memory device to a data reading device in said card reader and a data-sharing control device in said card reader at the same time.

12. The method of data transmission for card reader as claimed in claim 9, wherein the Step (4) further includes the steps of:
(41) Allow a computer system to cooperate with a managing system in said card reader to determine a type of said memory device via a control line connecting a data reading device to said memory device and a data transmission line connecting a data-sharing control device to said memory device, so as to perform data transmission; and
(42) Data input or output to or from said memory device starts under control of said control line, and via said data transmission line, which is the only data transmission path provided by said data transmission line through said data-sharing control device.

13. The method of data transmission for card reader as claimed in claim 10, wherein said data I/O interface is selected from the group consisting of USB, 1394, RS232, COM port, parallel port, PS2, PCMCIA, 802.11 series, Bluetooth, and infrared systems.

14. The method of data transmission for card reader as claimed in claim 10, wherein said managing system further includes at least one control unit, at least one memory unit, and at least one processing unit.

15. The method of data transmission for card reader as claimed in claim 10, wherein said data reading device comprises a card access device, such as a card slot configuration.

16. The method of data transmission for card reader as claimed in claim 15, wherein said card slot configuration is selected from the group consisting of a multiple-in-one card slot and a plurality of card slots.

17. The method of data transmission for card reader as claimed in claim 10, wherein said memory device is of a type selected from the group consisting of Compact Flash Card, IBM Micro-drive, Smart Media Card, xD-picture Card, Multi-media Card, Secure Digital Card, Memory Stick Card, and Memory Stick Pro Card.

18. The method of data transmission for card reader as claimed in claim 10, wherein said computer system is selected from the group consisting of general computers and data storing devices.
